(19) United States
(12) Patent Application Publication
(10) Pub. No.: US 2022/0329702 A1
(43) Pub. Date: Oct. 13, 2022

(54) IMAGE PROCESSING APPARATUS AND CONTROL METHOD THEREOF, AND STORAGE MEDIUM

(71) Applicant: CANON KABUSHIKI KAISHA, Tokyo (JP)

(72) Inventor: Kenji Kasuya, Kanagawa (JP)

(21) Appl. No.: 17/709,954

(22) Filed: Mar. 31, 2022

(30) Foreign Application Priority Data
Apr. 8, 2021 (JP) 2021-066067

(51) Int. Cl. H04N 1/00; H04L 51/48; G06V 30/414

(52) U.S. Cl. CPC H04N 1/00212; H04N 1/00331; H04N 1/00214; H04L 51/48; G06V 30/414

(57) ABSTRACT

An image processing apparatus registers a transmission source e-mail address indicating a transmission source of an image of a document including information necessary for transfer processing using a server apparatus providing banking services. The apparatus displays, on a display unit, a list of one or more e-mails received from the registered transmission source e-mail address registered by the registration unit among e-mails received from an external apparatus, and accepts user operation of selecting an e-mail to be processed from the list. The apparatus executes the transfer processing using the server apparatus based on information acquired by performing character recognition processing on an image attached to the e-mail to be processed.

### BACKGROUND OF THE INVENTION

### Field of the Invention

The present invention relates to an image processing apparatus and a control method thereof, and a storage medium.

### Description of the Related Art

There is known an automatic transaction system that reads character information written on an account transfer request form or the like by optical character recognition, and performs transfer or withdrawal processing based on the character information acquired. Japanese Patent Laid-Open No. 2013-109726 discloses an automatic transaction system that captures an image of a transfer destination sheet, acquires character data from the captured image by character recognition, identifies a financial institution name, a branch name, a subject, and an account number from the character data, and performs a transaction based on the character data identified.

Meanwhile, in an Internet-based service for performing transfer or withdrawal processing, it is common for a user to access the service by using a web browser. Further, in recent years, a system for accessing such a service by using a Web API application released by a service provider instead of using a web browser has been also provided.

When transfer processing is performed using a Web API as described above, there may be a case where a document such as a bill describing information necessary for the transfer processing is acquired as an image attached to an e-mail. In that case, it is necessary to select an image to be used for the transfer processing from a plurality of images received by e-mail, and it may be difficult to find a desired image.

### SUMMARY OF THE INVENTION

Therefore, an object of the present invention is to provide a technique for facilitating an image processing apparatus to find an image to be used for transfer processing from a plurality of images received by e-mail.

According to one aspect of the present invention, there is provided an image processing apparatus comprising: a registration unit configured to register a transmission source e-mail address indicating a transmission source of an image of a document including information necessary for transfer processing using a server apparatus providing banking services; an acceptance unit configured to display, on a display unit, a list of one or more e-mails received from the transmission source e-mail address registered by the registration unit among e-mails received from an external apparatus, and accept user operation of selecting an e-mail to be processed from the list; and an execution unit configured to execute the transfer processing using the server apparatus based on information acquired by performing character recognition processing on an image attached to the e-mail to be processed.

According to another aspect of the present invention, there is provided a method of controlling of an image processing apparatus, the method comprising: registering a transmission source e-mail address indicating a transmission source of an image of a document including information necessary for transfer processing using a server apparatus providing banking services; displaying, on a display unit, a list of one or more e-mails received from the registered transmission source e-mail address among e-mails received from an external apparatus, and accepting user operation of selecting an e-mail to be processed from the list; and executing the transfer processing using the server apparatus based on information acquired by performing character recognition processing on an image attached to the e-mail to be processed.

According to still another aspect of the present invention, there is provided a non-transitory computer-readable storage medium storing a computer program for causing a computer to execute method of controlling of an image processing apparatus, the method comprising: registering a transmission source e-mail address indicating a transmission source of an image of a document including information necessary for transfer processing using a server apparatus providing banking services; displaying, on a display unit, a list of one or more e-mails received from the registered transmission source e-mail address among e-mails received from an external apparatus, and accepting user operation of selecting an e-mail to be processed from the list; and executing the transfer processing using the server apparatus based on information acquired by performing character recognition processing on an image attached to the e-mail to be processed.

Further features of the present invention will become apparent from the following description of exemplary embodiments (with reference to the attached drawings).

### BRIEF DESCRIPTION OF THE DRAWINGS

FIG. 1 illustrates a configuration example of a communication system.

FIG. 2 is a block diagram illustrating a configuration example of an image forming apparatus.

FIG. 3 illustrates an example of a configuration of a console unit of an image forming apparatus and an operation screen displayed on the console unit.

FIGS. 4A to 4C illustrate examples of setting screens for usage authentication for banking services.

FIGS. 5A to 5C illustrate examples of web browser screens for usage authentication for banking services.

FIG. 6 illustrates an example of a sequence of usage authentication for banking services.

FIGS. 7A to 7C are flowcharts illustrating a procedure of the first transfer processing.

FIGS. 8A to 8C illustrate examples of screens displayed during the first transfer processing.

FIGS. 9A to 9D illustrate examples of screens displayed during the first transfer processing.

FIG. 10 illustrates an example of a bill image attached to an e-mail.

FIGS. 11A to 11G illustrate examples of screens displayed during the first transfer processing.

FIG. 12 illustrates an example of a sequence of transfer processing (S717).

FIGS. 13A to 13D illustrate examples of screens displayed during the first transfer processing.

FIG. 14 illustrates an example of a home screen with a shortcut button added.

FIGS. 15A and 15B are flowcharts illustrating a procedure of the second and subsequent transfer processing.

FIGS. 16A to 16E illustrate examples of screens displayed during the second and subsequent transfer processing, and an example of a bill image.

FIG. 17 is a flowchart illustrating a procedure of check processing (S1512) for an inconsistent point in transfer destination information.

FIG. 18 illustrates an example of a confirmation screen in check processing for an inconsistent point.

FIG. 19 illustrates an example of a screen displayed during the second and subsequent transfer processing according to a second embodiment.

FIGS. 20A to 20B illustrate examples of screens for editing filter conditions.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

<Communication System>

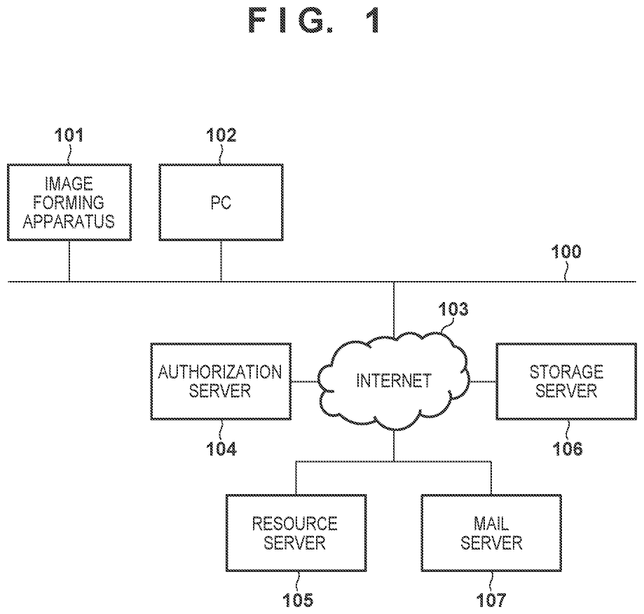

FIG. 1 illustrates a configuration example of a communication system according to a first embodiment. The communication system includes an image forming apparatus 101 and a PC 102 connected via a network 100 including a wired LAN or wireless LAN, or the like. The network 100 is connected to the Internet 103. The communication system further includes an authorization server 104, a resource server 105, a storage server 106, and a mail server 107 connected via the Internet 103. The image forming apparatus 101, the PC 102, and the above-described server apparatuses on the Internet 103 are configured to be communicable with each other via the network 100 and the Internet 103. Image data transmitted and received between apparatuses included in the communication system may be any of electronic data acquired by converting an image into RAW data, electronic data compatible with an image format such as TIFF, JPEG and the like, and electronic data compatible with a PDF format.

The image forming apparatus 101 is an example of an image processing apparatus and has an e-mail transmission and reception function in addition to various functions such as printing function, copying function, scanning function, and facsimile (fax) function. The image forming apparatus 101 may receive an e-mail transmitted from an external apparatus (not illustrated) from the mail server 107. Besides, the image forming apparatus 101 may form (print) an image attached to a received e-mail onto a sheet and forward the image to an external apparatus such as the PC 102, the storage server 106 or other apparatuses.

The PC 102 is used to confirm and set the state of the image forming apparatus 101. The PC 102 can refer to or update set values of the image forming apparatus 101 by using the HTTP protocol. The authorization server 104 is a server apparatus having a function to authorize the use of a banking service API provided as a Web API. The resource server 105 is a server apparatus that provides banking services such as bank transfer, issue of account activity statements, and the like. The storage server 106 is a server apparatus that functions as an online storage and is used to store image data and setting information. The mail server 107 is a server apparatus used for transmission and reception of e-mails.

<Image Forming Apparatus>

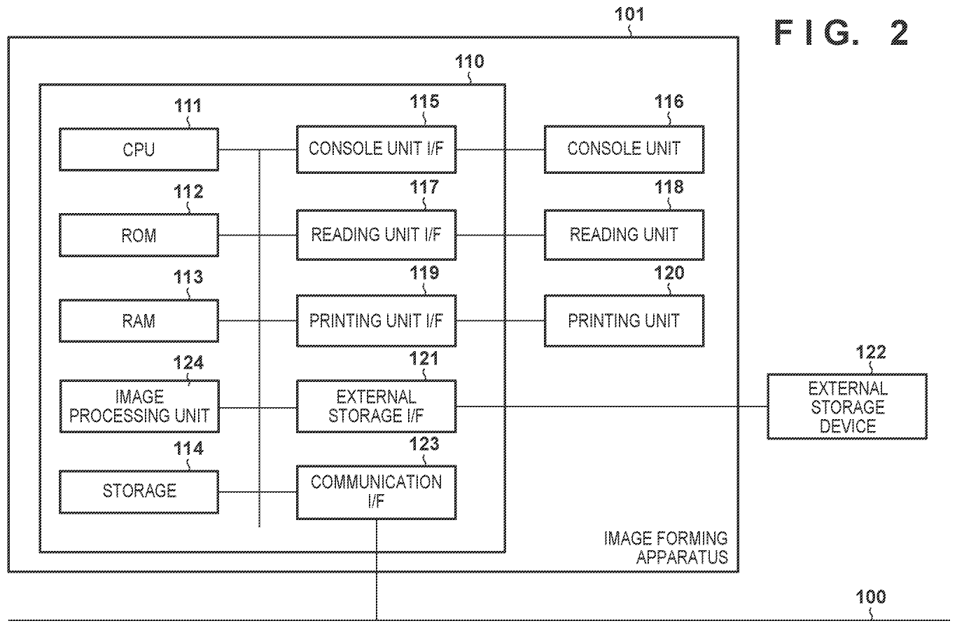

FIG. 2 is a block diagram illustrating a configuration example of the image forming apparatus 101. The image forming apparatus 101 includes a control unit 110, and a console unit 116, a reading unit 118, and a printing unit 120 connected to the control unit 110. The control unit 110 includes a CPU 111 and controls the entire operation of the image forming apparatus 101. The control unit 110 includes the CPU 111, a ROM 112, a RAM 113, a storage 114, a console unit I/F (interface) 115, a reading unit I/F 117, a printing unit I/F 119, an external storage I/F 121, a communication I/F 123, and an image processing unit 124.

The CPU 111 reads out and executes control programs stored in the ROM 112 or the storage 114 to perform various types of control such as reading control, print control, and communication control. The ROM 112 stores control programs executable by the CPU 111. The ROM 112 also stores a boot program, font data, and the like. The RAM 113 is a main memory of the CPU 111 and is used as a work area or a temporary storage area for deploying the control programs stored in the ROM 112 and the storage 114. The storage 114 stores image data, print data, an address book, shortcuts, various programs, and various setting information. The storage 114 according to the present embodiment includes a flash memory, but may include an auxiliary storage apparatus such as SSD, HDD, and eMMC.

In the image forming apparatus 101 according to the present embodiment, when the CPU 111 executes one of programs stored in one or more memories (RAM 113), the processing illustrated in each flowchart to be described later is executed. However, at least a part of the processing illustrated in each flowchart may be executed using a hardware circuit such as ASIC or FPGA.

The reading unit I/F 117 is an interface that connects the reading unit 118 and the control unit 110. The reading unit 118 reads an image of original document and generates image data (binary data, or the like) corresponding to the image. The image data generated by the reading unit 118 can be used to be transmitted to an external apparatus, stored to an external recording apparatus, and printed onto a sheet (a recording paper). The printing unit I/F 119 is an interface that connects the printing unit 120 and the control unit 110. The CPU 111 forwards image data for printing (image data of an image to be printed) to the printing unit 120 via the printing unit I/F 119. Then, the printing unit 120 prints the image on a sheet fed by a sheet feeding cassette (not illustrated) using a toner supplied from a cartridge (not illustrated) based on the image data received.

The console unit I/F 115 is an interface that connects the console unit 116 and the control unit 110. The console unit 116 includes a display unit (a display) having a touch panel function and is used to display information to a user and receive input from a user. The external storage I/F 121 is an interface that connects the external storage device 122 and the control unit 110. The CPU 111 may store image data in the external storage device 122 via the external storage I/F 121. In the present embodiment, it is assumed that the external storage I/F 121 is a USB interface and the external storage device 122 is a USB memory. However, an external storage apparatus other than a USB memory, such as an SD card, may be connectable to the external storage I/F 121.

The control unit 110 is connected to the network 100 via the communication I/F 123. The communication I/F 123 can communicate with the PC 102 and the like via the network 100 and can further communicate with each server apparatus on the Internet 103. For example, the communication I/F 123 may transmit image data to the PC 102, transmit various setting information inside the image forming apparatus 101 to the PC 102, transmit and receive e-mails via the mail server 107, and transmit image data to the storage server 106.

The communication I/F 123 is connected to the authorization server 104 and acquires an authorization code for a banking service API provided by the resource server 105. Further, the communication I/F 123 is connected to the resource server 105 and presents an authorization code for a banking service API to executes a banking service via the banking service API. The communication I/F 123 is configured such that registration or change of various setting information for acquiring an authorization code for a banking service API can be performed from the PC 102 via an HTTP connection.

The image processing unit 124 performs image processing on image data (input image data) generated by the reading unit 118 and on image data (output image data) to be used for printing by the printing unit 120. The image processing unit 124 may perform image processing such as resolution conversion, color conversion, compression/decompression, halftone processing, and the like. The image processing unit 124 may also perform character recognition processing (OCR processing) to recognize characters from an image and output character data (character information). For example, the image processing unit 124 may output character data by performing character recognition processing on image data generated by the reading unit 118 and on image data attached to an e-mail received from the mail server 107 via the communication I/F 123. In the present embodiment, the CPU 111 may perform character recognition processing on an image attached to an e-mail to be processed using the image processing unit 124 in order to acquire information necessary for the transfer processing using the resource server 105.

<Console Unit and Home Screen>

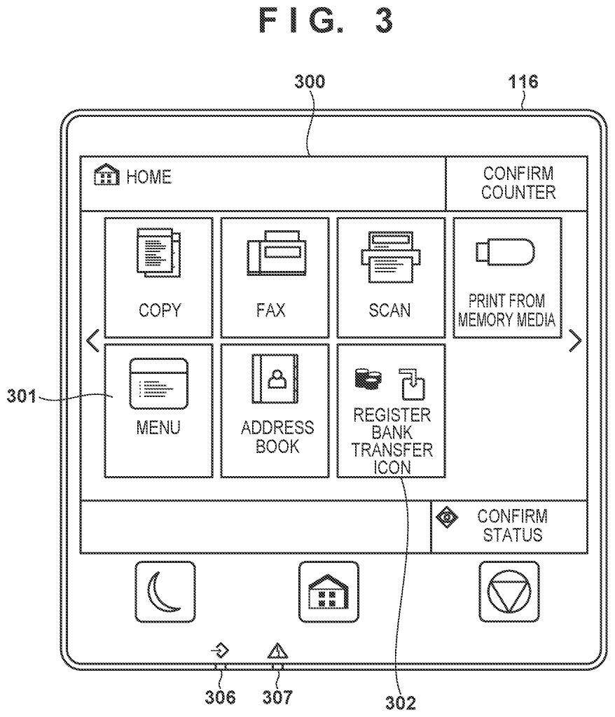

FIG. 3 illustrates an example of a configuration of the console unit 116 and an operation screen displayed on a display unit (display) of the console unit 116. The console unit 116 includes a display unit 300 having a touch panel function and LED lamps 306 and 307. The LED lamps 306 and 307 are used to inform a user of the state of the image forming apparatus 101. The LED lamp 306 lights up while the image forming apparatus 101 is executing a job, and the LED lamp 307 lights up when any error occurs in the image forming apparatus 101.

FIG. 3 illustrates a home screen to be displayed immediately after boot-up of the image forming apparatus 101 as an example of an operation screen to be displayed on the display unit 300. The home screen is an example of an operation screen for selecting a function included in the image forming apparatus 101 and is used to instruct the execution of each function of the image forming apparatus 101. The home screen displays buttons corresponding to the functions included in the image forming apparatus 101, such as copy, fax, scan, menu, and address book. A user can press (touch) a button displayed on the home screen to instruct the execution of a function corresponding to the button. For example, by pressing a button 302 displayed on the home screen, it is possible to instruct the execution of bank transfer (transfer processing using the resource server 105) and the registration of transfer destination information.

<Usage Authentication for Banking Services>

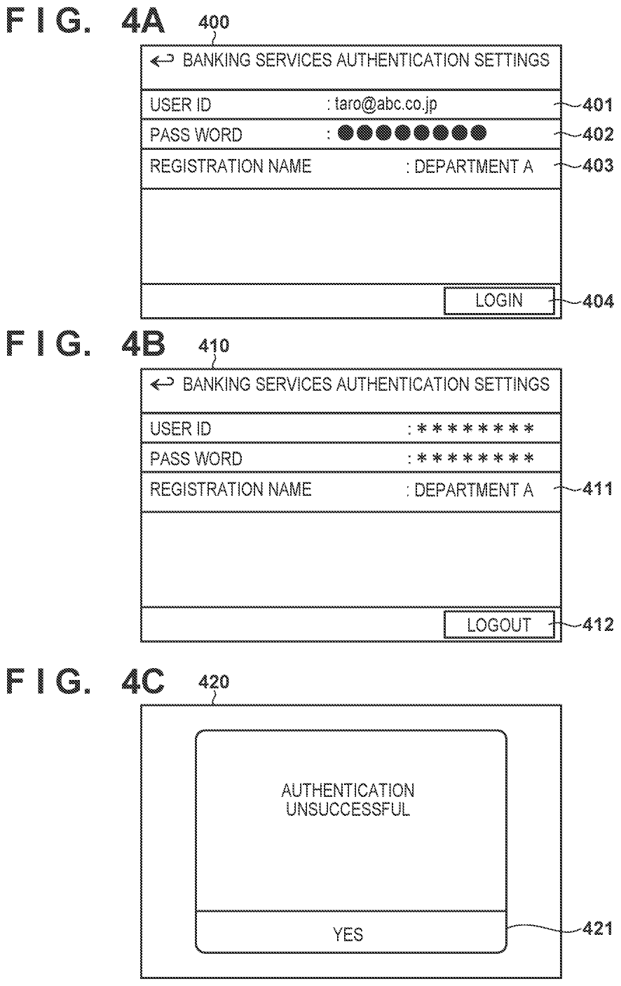

FIGS. 4A to 4C illustrate examples of setting screens for usage authentication for banking services. User information set using setting screens displayed is used as user information of a transfer source when bank transfer (transfer processing) is performed using a banking service.

In the image forming apparatus 101 according to the present embodiment, when a user select a “Menu” button 301 displayed on the home screen, a setting menu of each application is displayed on the display unit 300. A setting screen 400 illustrated in FIG. 4A is displayed on the console unit 116 when a user instructs the setting related to the usage authentication for banking services by using a setting menu of an application for using a banking service.

The setting screen 400 illustrated in FIG. 4A includes input fields 401 and 402 for inputting a user ID and a password, respectively, as user information. A password input in the input field 402 is converted into masked characters. In authentication processing, a user ID and a password input in the input fields 401 and 402 are checked against a user ID and a password registered in advance for use of banking services. The setting screen 400 further includes an input field 403 for inputting a registration name for a banking service. A registration name input in the input field 403 is used as a name for identifying a transfer source in transfer processing. Such a registration name is set in association with an account of a transfer source.

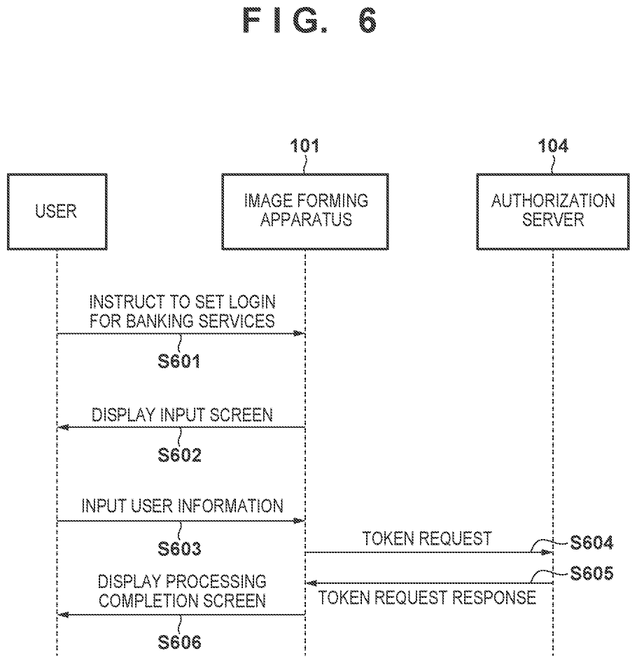

When a log-in button 404 of the setting screen 400 is pressed, the image forming apparatus 101 performs authentication processing using the authorization server 104 according to the sequence illustrated in FIG. 6. Upon successful authentication based on user information input via the setting screen 400, the image forming apparatus 101 displays a screen 410 illustrated in FIG. 4B on the console unit 116. On the screen 410, a user ID and a password input in the input field 401 and 402 of the setting screen 400 are converted into masked characters, and only a registration name 411 is displayed. When a log-out button 412 of the screen 410 is pressed, the image forming apparatus 101 returns the display screen of the console unit 116 back to the setting screen 400 and clears the input fields 401 to 403 in the setting screen 400.

On the other hand, when the authentication based on user information input via the setting screen 400 fails, the image forming apparatus 101 displays a screen 420 illustrated in FIG. 4C on the console unit 116. When a “Yes” button 421 of the screen 420 is pressed, the display screen of the console unit 116 returns to the setting screen 400, and the input fields 401 to 403 in the setting screen 400 are cleared.

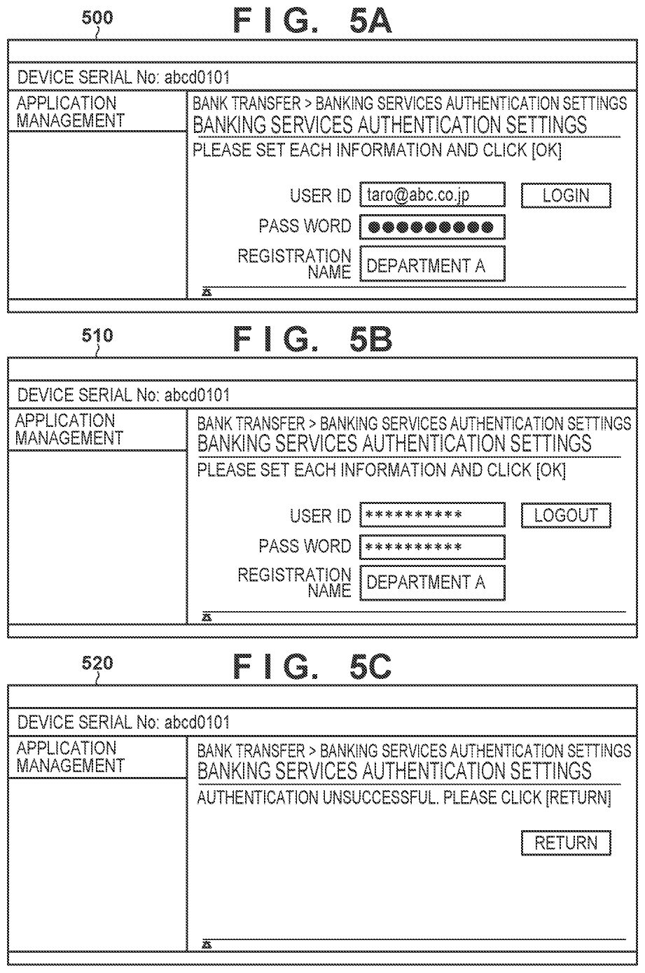

The image forming apparatus 101 according to the present embodiment may be configured such that an HTTP connection from the PC 102 to the image forming apparatus 101 is made using a web browser installed in the PC 102 so as to allow the setting similar to that described above to be performed via the PC 102. In that case, web browser screens 500, 510, and 520 illustrated in FIGS. 5A to 5C are displayed in a display unit (not illustrated) of the PC 102. The web browser screens 500, 510, and 520 have similar contents and provide similar functions as the screens 400, 410, and 420 illustrated in FIGS. 4A to 4C, respectively.

FIG. 6 illustrates an example of a sequence of usage authentication for banking services. A user operates the console unit 116 to give an instruction to make the setting of user information (log-in setting) for using banking services (accessing banking services) from the image forming apparatus 101 (S601). In response to the above instruction, the CPU 111 displays a screen for inputting the user information (the setting screen 400 illustrated in FIG. 4A) on the console unit 116 (S602). On the setting screen 400, the user inputs a user ID and a password as the user information in the input fields 401 and 402, respectively, and presses the log-in button 404 (S603). Upon pressing of the log-in button 404, the CPU 111 transmits, to the authorization server 104, a token request including the user ID and the password being input (S604).

Upon receipt of the token request from the image forming apparatus 101, the authorization server 104 performs usage authentication for banking services based on the user ID and the password included in the token request. Specifically, the authorization server 104 determines whether or not the user ID and the password included in the token request are valid by checking against the user ID and the password registered in advance. After having confirmed that the user ID and the password included in the token request are valid, the authorization server 104 transmits a token request response including an access token indicating the result of the usage authentication for banking services to the image forming apparatus 101 (S605).

In the image forming apparatus 101, the CPU 111 displays a processing completion screen indicating the result of the usage authentication on the console unit 116 based on the token request response received from the authorization server 104 (S606). Specifically, the CPU 111 stores the access token included in the token request response in the storage 114 in association with the user information. Further, after the storage of the access token is completed, the CPU 111 displays the screen 410 illustrated in FIG. 4B on the console unit 116 to end the processing according to the sequence illustrated in FIG. 6. On the other hand, when the token request response includes an access token indicating that the authentication has failed, the CPU 111 displays the screen 420 illustrated in FIG. 4C on the console unit 116 to end the processing according to the sequence illustrated in FIG. 6. In this case, the CPU 111 may request the user to input a password again.

<First Transfer Processing>

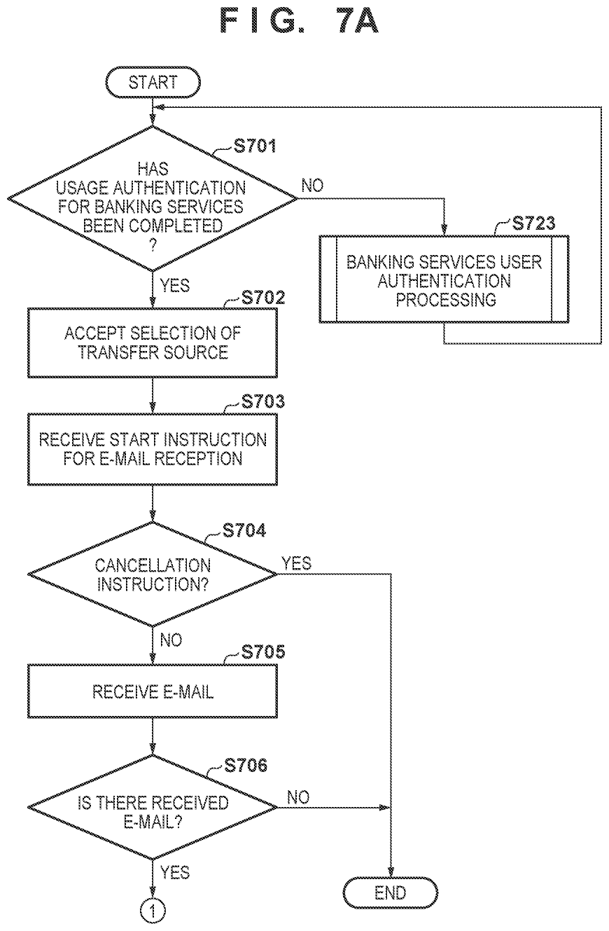

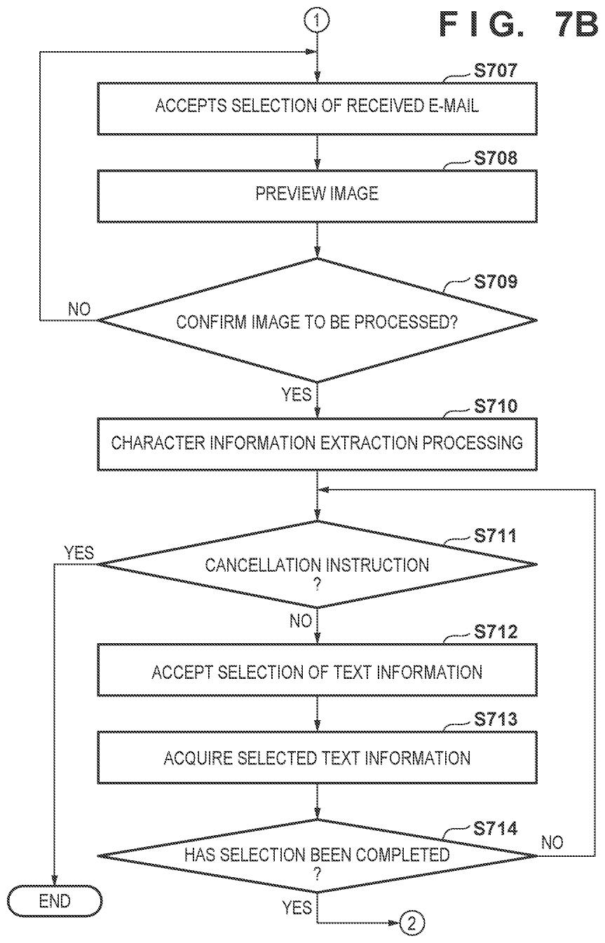

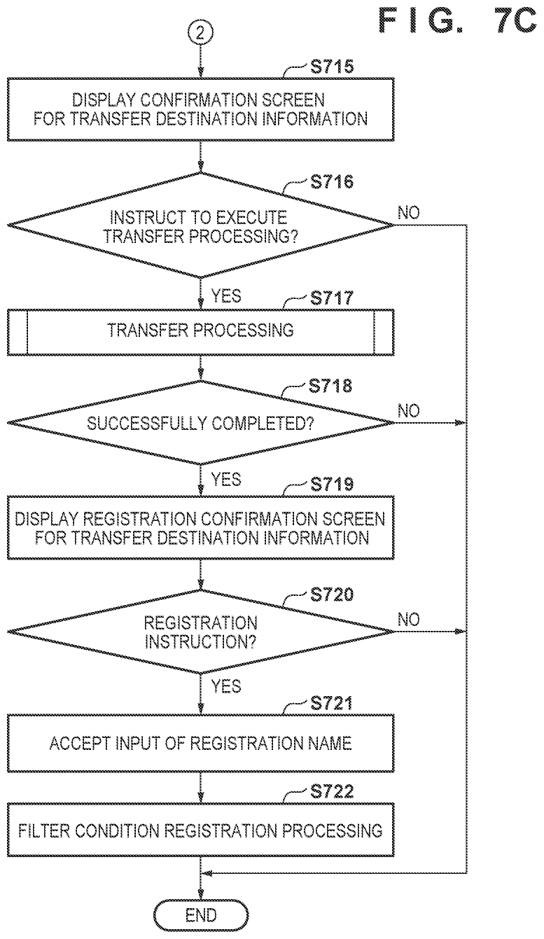

FIGS. 7A to 7C are flowcharts illustrating a procedure of the first transfer processing. The processing in each step of FIGS. 7A to 7C may be implemented in the image forming apparatus 101 when the CPU 111 reads out and executes control programs stored in the ROM 112 or the storage 114. The processing according to the procedure in FIGS. 7A to 7C is processing to be performed when a user instructs the execution of transfer processing without using transfer destination information registered by registration processing in steps S719 to S722 to be described later. A user can instruct the execution of transfer processing (and the registration of transfer destination information) without using already-registered transfer destination information, for example, by pressing the button 302 on the home screen (FIG. 3).

First, when the user presses the button 302 on the home screen (FIG. 3), the CPU 111 determines whether or not the usage authentication for banking services has been completed in S701. When the usage authentication for banking services has been completed, the CPU 111 advances the processing to S702. In a case where the usage authentication for banking services has not been completed, the CPU 111 advances the process to S723 and then displays the setting screen 400 (FIG. 4A) on the console unit 116 to perform the usage authentication according to the procedure in FIG. 6. Upon completion of the processing in S723, the CPU 111 returns the processing back to S701 to determine again whether or not the usage authentication has been completed.

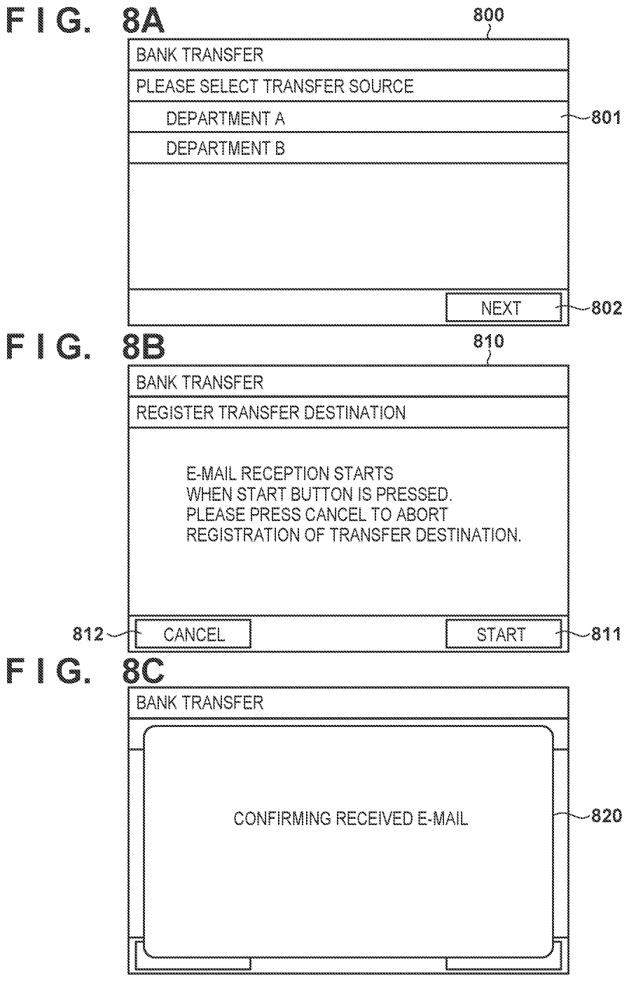

In S702, the CPU 111 displays a selection screen 800 illustrated in FIG. 8A on the console unit 116 and accepts user operation of selecting any transfer source from among already-registered transfer sources. Transfer sources that can be selected by the user in S702 are the transfer sources already registered by the user according to the procedure in FIG. 6. After a transfer source is selected and a “Next” button 802 is pressed on the selection screen 800, in S703, the CPU 111 displays a screen 810 illustrated in FIG. 8B on the console unit 116 and receives a start instruction for e-mail reception from the user. Upon receipt of a cancellation instruction issued by pressing of a “Cancel” button 812 on the screen 810 (“Yes” in S704), a sequence of processing according to the procedure in FIGS. 7A to 7C is ended. On the other hand, upon receipt of a start instruction for e-mail reception issued by pressing of a “Start” button 811 on the screen 810 (“No” in S704), the processing is advanced to S705.

In S705, the CPU 111 displays a screen 820 illustrated in FIG. 8C on the console unit 116 and starts receiving an e-mail from the mail server 107. In the present embodiment, an e-mail attached with an image (image data) of a bill to be used for transfer processing as an image of a document including information necessary for the transfer processing using the resource server 105 (transfer destination information and a transfer amount) is received from the mail server 107. The document including transfer destination information and a transfer amount, which are necessary for the transfer processing, may be a document other than a bill.

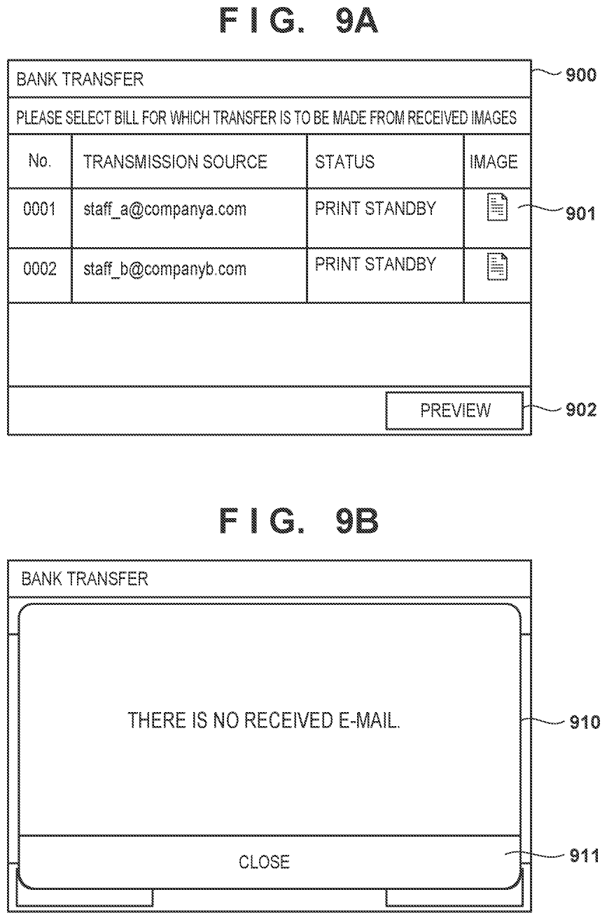

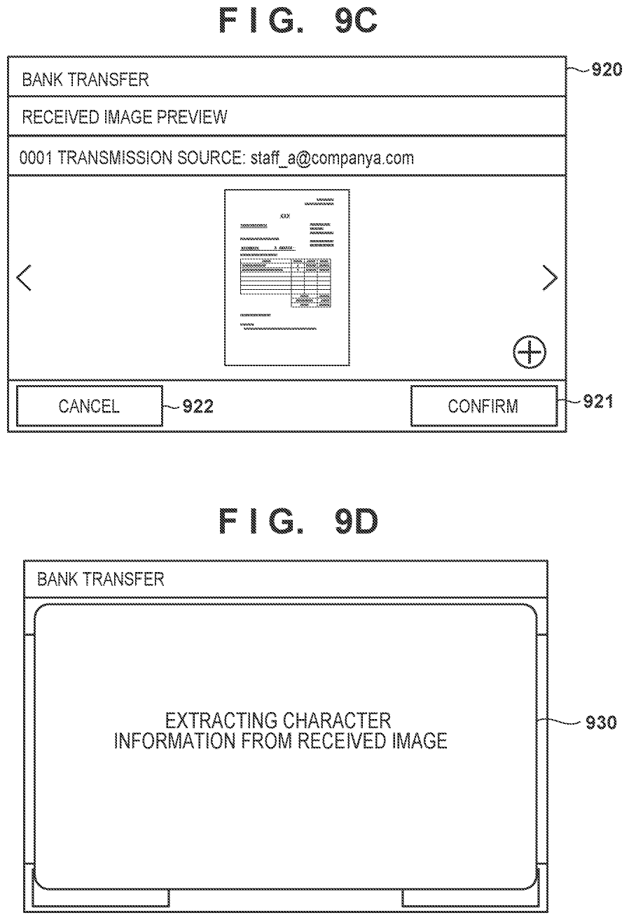

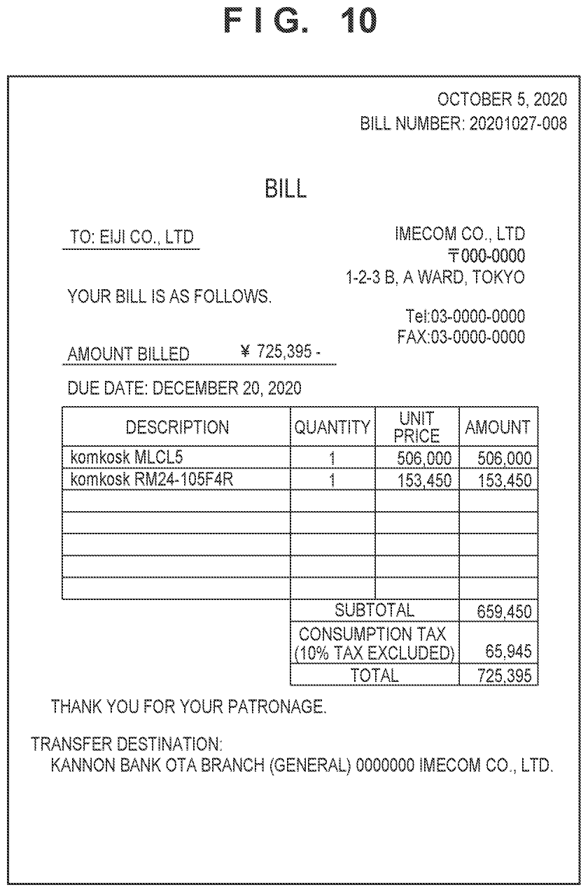

In S706, the CPU 111 determines whether or not there is an e-mail received from the mail server 107, and when there is a received e-mail, advances the processing to S707. In S707, the CPU 111 displays a screen 900 illustrated in FIG. 9A on the console unit 116 and accepts user operation of selecting a received e-mail to be processed from a list 901 of received e-mails. In this manner, the CPU 111 displays a list of e-mails received from the mail server 107 (external apparatus) on the console unit 116 and accepts user operation of selecting an e-mail to be processed from the list. Each received e-mail and image data attached to each received e-mail are temporarily stored in the RAM 113. On the other hand, when there is no received e-mail, the CPU 111 displays a screen 910 illustrated in FIG. 9B on the console unit 116 and ends a sequence of processing according to the procedure in FIGS. 7A to 7C in response to the user pressing a “Close” button 911.

When an e-mail is selected and a “Preview” button 902 is pressed by the user on the screen 900 displayed on the console unit 116, in S708, the CPU 111 displays a preview screen 920 illustrated in FIG. 9C on the console unit 116. The preview screen 920 displays a bill image corresponding to the image data attached to the received e-mail assigned with a number “No. 0001” on the screen 900. FIG. 10 illustrates an example of a bill image based on the image data attached to the received e-mail “No. 0001”, and the bill image is displayed on the preview screen 920.

When a “Confirm” button 921 is pressed by the user on the preview screen 920, the CPU 111 confirms the image to be processed (“Yes” in S709) and advances the processing to S710. On the other hand, when a “Cancel” button 922 is pressed by the user on the preview screen 920 (“No” in S709), the CPU 111 returns the processing back to S707 to accept again the selection of a received e-mail by the user on the screen 900.

In S710, the CPU 111 displays a screen 930 illustrated in FIG. 9D on the console unit 116 and executes a process of extracting character information (text objects) from the bill image. This process is achieved by OCR processing on the bill image. The CPU 111 executes the OCR processing on the image data of the bill image that has been stored in the RAM 113 and has been confirmed as the image to be processed in S709. In the OCR processing, the vicinity of each extracted character is searched in a horizontal direction, a text consisting of characters located within a predetermined distance is extracted as a text object, and position information indicating the position of the text object is assigned to the text object.

Upon completion of the processing in S710, the CPU 111 displays the extracted text objects on the console unit 116 in order to acquire the information necessary for the transfer processing (transfer destination information and a transfer amount). In the present embodiment, the CPU 111 acquires the transfer destination information and the transfer amount by accepting user operation of associating the extracted text objects (character information) with each item of the transfer destination information and the transfer amount in the console unit 116.

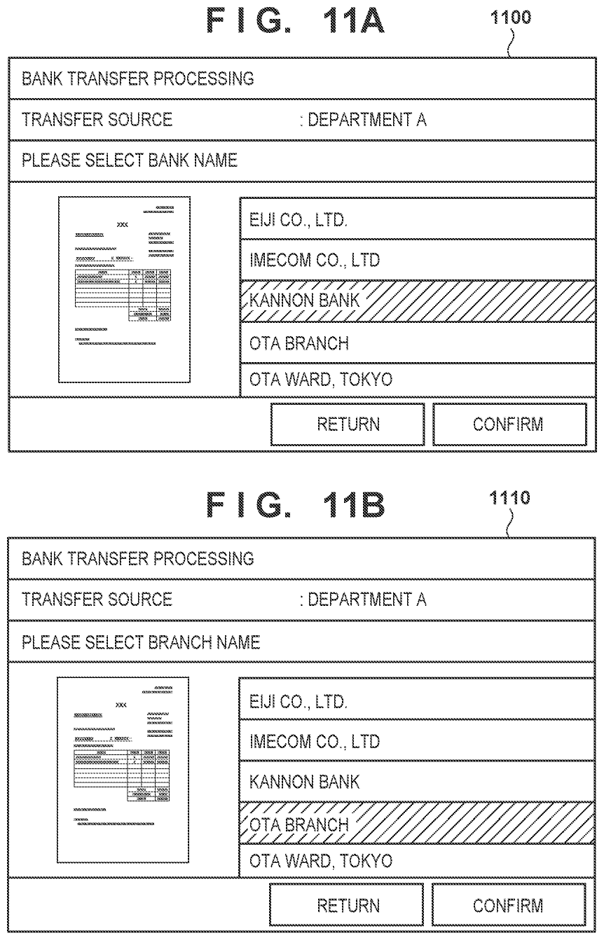

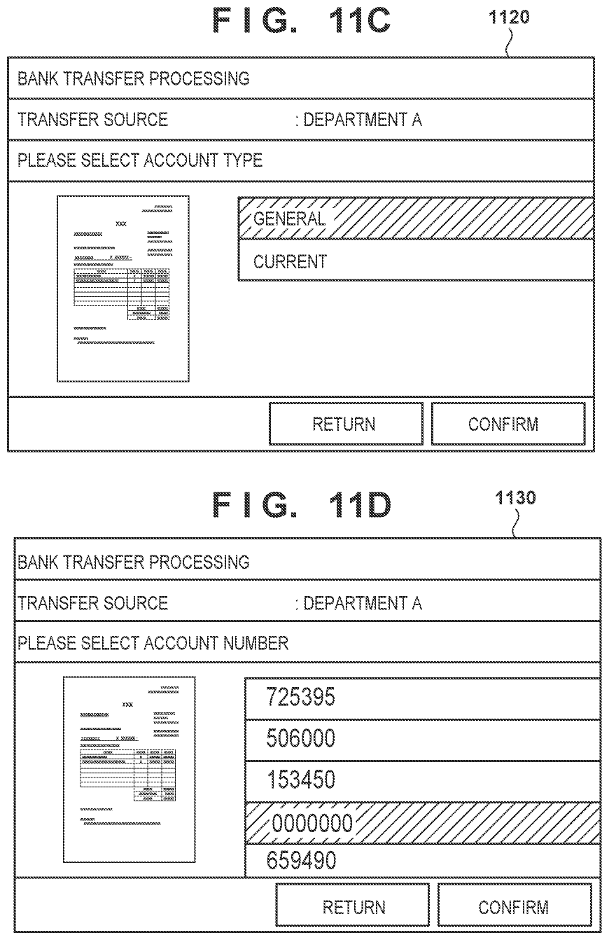

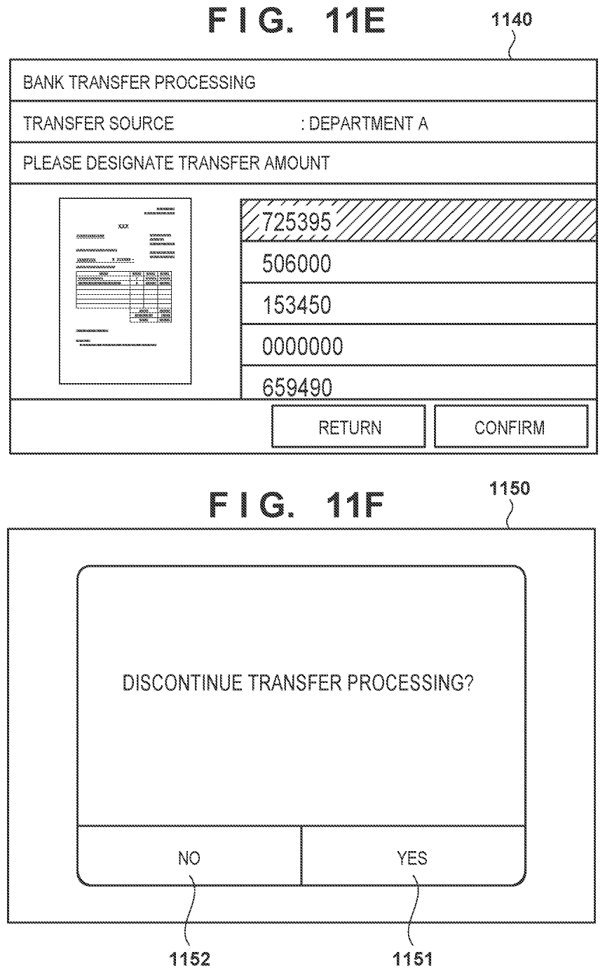

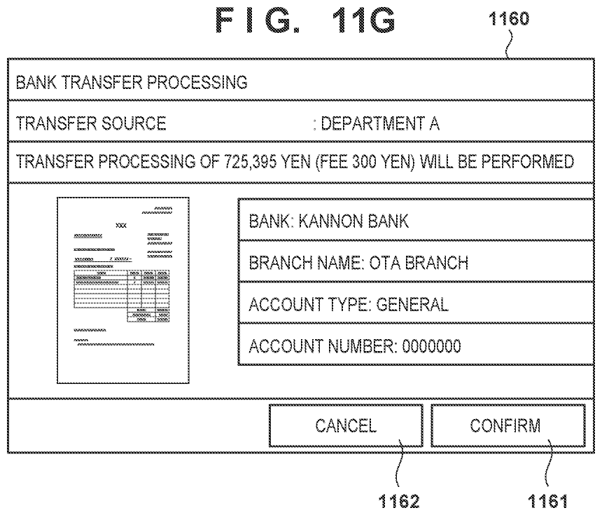

Screens 1100, 1110, 1120, 1130, and 1140 illustrated in FIGS. 11A to 11E are examples of selection screens for selecting text objects, which are sequentially displayed on the console unit 116. On each of the screens 1100, 1110, 1120, 1130, and 1140, the screen displayed on the console unit 116 switches to the subsequent screen when a “Confirm” button is pressed, and the screen displayed on the console unit 116 switches to the previous screen when a “Back” button is pressed. When the “Back” button is pressed on the screen 1100, a confirmation screen 1150 illustrated in FIG. 11F is displayed on the console unit 116 to confirm with the user whether or not to discontinue the transfer processing. When the cancellation of the transfer processing is instructed by pressing of a “Yes” button 1151 on the confirmation screen 1150 (“Yes” in S711), the CPU 111 ends a sequence of processing according to the procedure in FIGS. 7A to 7C. When a “No” button 1152 is pressed on the confirmation screen 1150, the CPU 111 returns the screen displayed on the console unit 116 back to the screen 1100.

In S712, the CPU 111 accepts user's selection of the text objects corresponding to each item of the transfer destination information and the transfer amount from among the text objects extracted from the bill image via the screens displayed on the console unit 116. In the examples of FIGS. 11A to 11G, the CPU 111 accepts the selection of the text objects indicating a bank name, a branch name, an account type, an account number, and a transfer amount via the screens 1100, 1110, 1120, 1130, and 1140, respectively. In accordance with the selection of the text objects by the user, the CPU 111 acquires the text objects selected for each item of the transfer destination information and the transfer amount in S713. Then, in S714, the CPU 111 determines whether or not the selection of the text objects corresponding to each item of the transfer destination information and the transfer amount has been completed and advances the processing to S715 when the selection is determined to have been completed, or returns the processing back to S711 when the selection is determined not to have been completed. In the examples illustrated in FIGS. 11A to 11G, when the “Confirm” button is pressed on the screen 1140, the CPU 111 determines that the selection of the text objects has been completed. In this manner, the CPU 111 acquires the transfer destination information and the transfer amount by accepting user operation for selecting the text objects by the user (associating the character information extracted from the bill image with each item of the transfer destination information and the transfer amount).

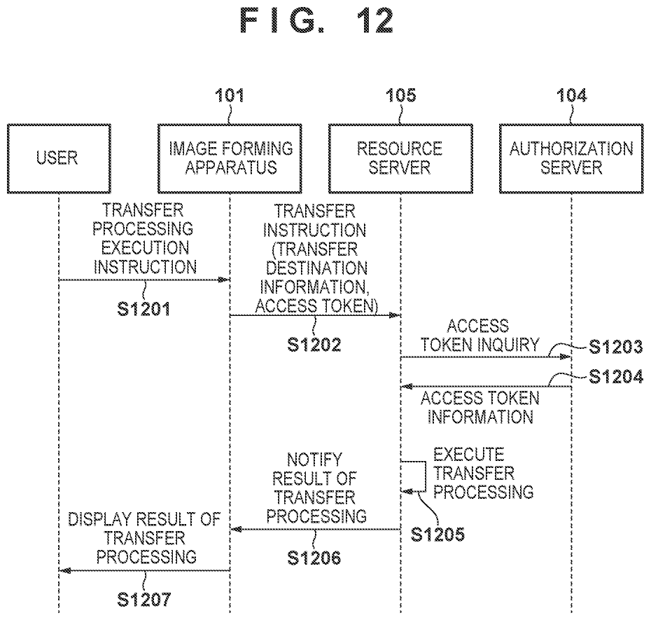

In S715, the CPU 111 displays, on the console unit 116, a confirmation screen 1160 illustrated in FIG. 11G for the user to confirm the information necessary for the transfer processing (the transfer destination information and the transfer amount). When the user instructs to execute the transfer processing by pressing a “Confirm” button 1161 on the confirmation screen 1160 (“Yes” in S716), the CPU 111 advances the processing to S717. In S717, the CPU 111 executes the transfer processing using the resource server 105 and then advances the processing to S718. The transfer processing in S717 is executed in accordance with the sequence illustrated in FIG. 12 to be described later. On the other hand, when the user instructs to cancel the transfer processing by pressing a “Cancel” button 1162 on the confirmation screen 1160 (“No” in S716), a sequence of processing according to the procedure in FIGS. 7A to 7C is ended.

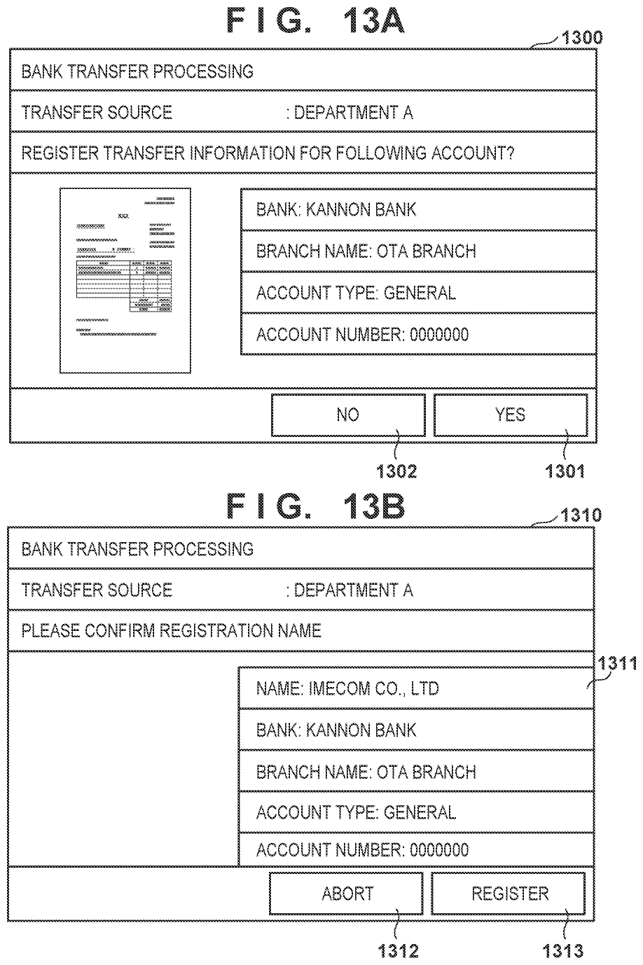

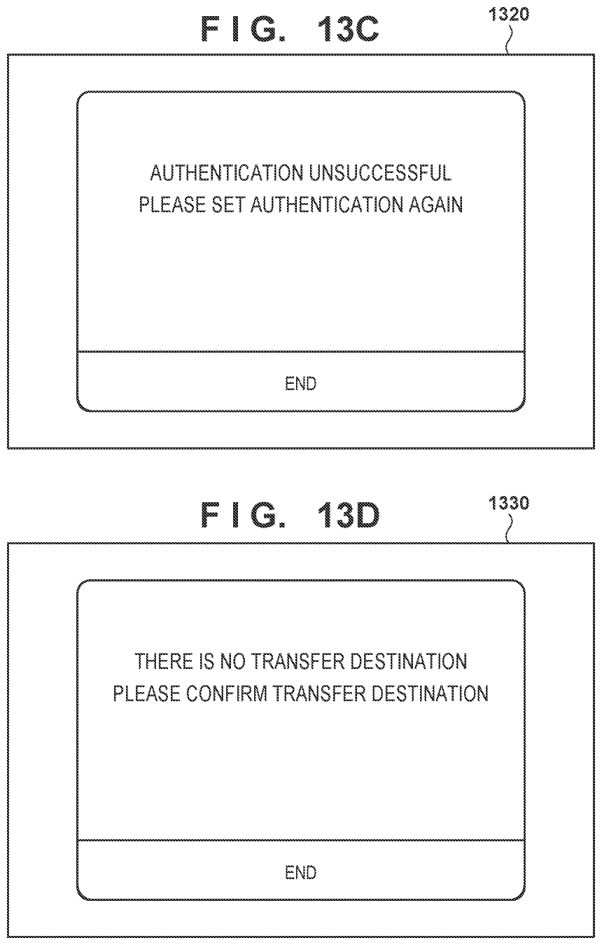

In S718, the CPU 111 determines whether or not the transfer processing (S717) has been successfully completed and advances the processing to S719 when the transfer processing is determined to have been successfully completed (“Yes” in S718). In S719, the CPU 111 displays, on the console unit 116, a registration confirmation screen 1300 illustrated in FIG. 13A for confirming with the user whether to register the transfer destination information and advances the processing to S720. On the other hand, when the transfer processing is determined not to have been successfully completed (“No” in S718), the CPU 111 displays cause that the transfer processing has not been successfully completed on the console unit 116 and ends a sequence of processing according to the procedure in FIGS. 7A to 7C. For example, in a case where the transfer processing has not been successfully completed due to a failure in authentication processing, the CPU 111 displays a screen 1320 illustrated in FIG. 13C on the console unit 116. Meanwhile, in a case where the transfer processing has not been successfully completed due to a nonexistence of the transfer destination, the CPU 111 displays a screen 1330 illustrated in FIG. 13D on the console unit 116.

When the user instructs to register the transfer destination information by pressing a “Yes” button 1301 on the registration confirmation screen 1300 (“Yes” in S720), the CPU 111 advances the processing to S721. On the other hand, when the user instructs not to register the transfer destination information by pressing a “No” button 1302 on the registration confirmation screen 1300 (“No” in S720), the CPU 111 ends a sequence of processing according to the procedure in FIGS. 7 A to 7C.

In S721, the CPU 111 displays an input screen 1310 illustrated in FIG. 13B on the console unit 116 and accepts an input of a registration name for identifying the transfer destination. The input screen 1310 includes an input field 1311 for inputting a registration name. When an “Abort” button 1312 is pressed on the input screen 1310, the CPU 111 ends a sequence of processing according to the procedure in FIGS. 7A to 7C. When a registration name is input in the input field 1311 and then a “Register” button 1313 is pressed on the input screen 1310, the CPU 111 registers the transfer destination information (stores in the storage 114). At this time, the CPU 111 also registers position information indicating positions where the character information (the text objects) of each item of the transfer destination information and the transfer amount is arranged in the bill image, together with the transfer destination information. The transfer destination information includes information indicating at least any one of a registration name for identifying a transfer destination, a bank name, a branch name, an account type, and an account number.

After the registration of the transfer destination information and the position information is completed, in S722, the CPU 111 also registers, as a filter condition, the transmission source e-mail address of the received e-mail, which has been selected as a processing target in S707, in association with the transfer destination information and the position information. This filter condition is used as a condition for identifying e-mails to be displayed on the console unit 116 as candidates for a processing target among e-mails received from an external apparatus. In this manner, after completion of the transfer processing (S717) based on the bill image attached to the processing target e-mail, the CPU 111 registers the transfer destination information used for the transfer processing and the transmission source e-mail address of the e-mail in association with each other. Thus, the transfer destination information used for the first transfer processing can be reused for the next and subsequent transfer processing.

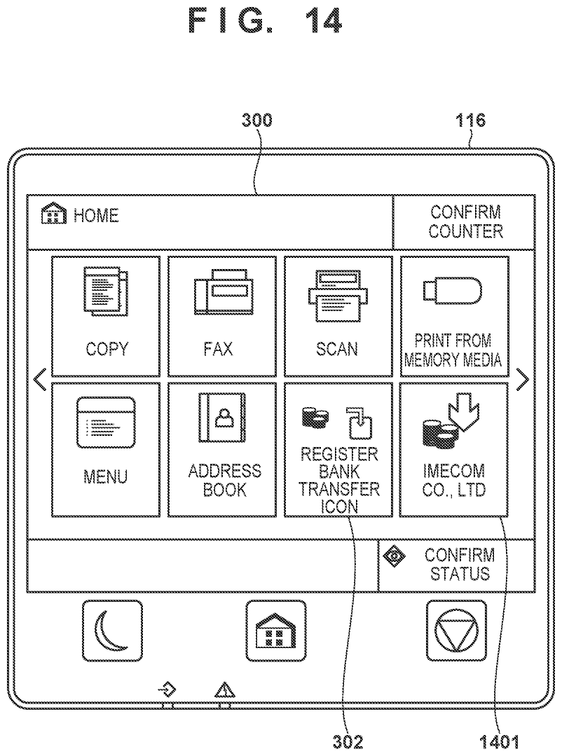

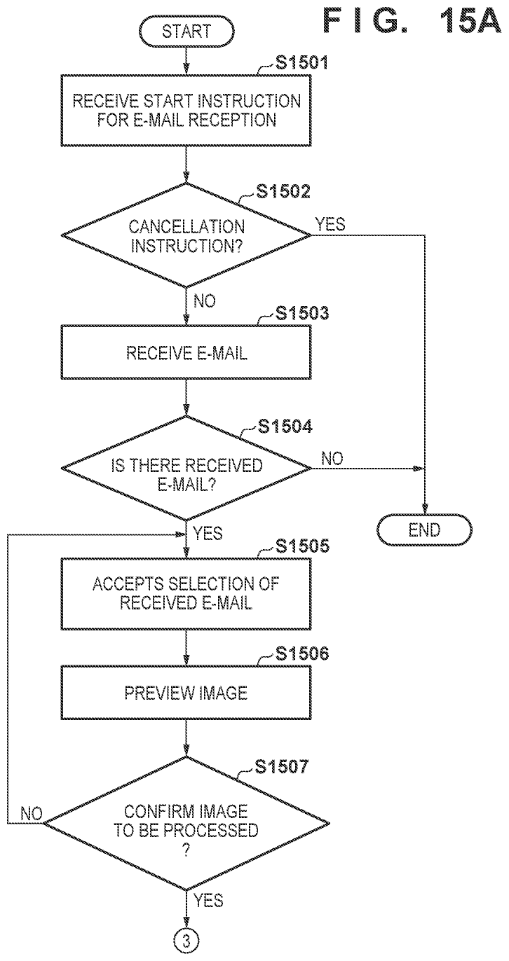

Further, in S722, the CPU 111 adds, on the home screen, a shortcut button to be used by the user to instruct the execution of the next and subsequent (the second and subsequent) transfer processing by reusing the transfer destination information registered. This shortcut button is associated with the transmission source e-mail address registered as the filter condition. As an example of such a shortcut, FIG. 14 illustrates an example in which a shortcut button 1401 is added on the home screen illustrated in FIG. 3. In this manner, the CPU 111 adds the shortcut button 1401 to the operation screen (the home screen) for selecting a function of the image forming apparatus 101 displayed on the console unit 116. The shortcut button 1401 is an example of an instruction object to be used by the user to instruct the execution of the transfer processing based on the transfer destination information registered in association with the transmission source e-mail address. In the present example, in order for the user to be able to identify the transfer destination, the registration name included in the registered transfer destination information is indicated on the shortcut button 1401. Upon completion of the creation of the shortcut button 1401, the CPU 111 ends a sequence of processing according to the procedure in FIGS. 7A to 7C.

Note that, the present embodiment describes an example in which the transmission source e-mail address that indicates the transmission source of the bill image used for the transfer processing is registered in association with the transfer destination information, but the present embodiment is not limited to this example. For example, transfer destination information and an e-mail address (transmission source e-mail address) input by a user using the console unit 116 may be registered in association with each other.

<Transfer Processing (S717)>

FIG. 12 illustrates an example of a sequence of transfer processing (S717). For example, a user gives an instruction to execute transfer processing by pressing the “Confirm” button 1161 on the confirmation screen 1160 illustrated in FIG. 11G (S1201). Upon receipt of the instruction, the image forming apparatus 101 transmits a transfer instruction including an access token and transfer destination information to the resource server 105 (S1202).

Upon receipt of the transfer instruction from the image forming apparatus 101, the resource server 105 retrieves the access token from the transfer instruction and makes an inquiry to the authorization server 104 about the access token (S1203). In response to the inquiry, the authorization server 104 returns information about the access token to the resource server 105 (S1204). The resource server 105 determines the validity of the access token based on the information about the access token received from the authorization server 104 and executes the transfer processing when the access token is valid (S1205). Besides, the resource server 105 notifies the image forming apparatus 101 of the execution result of the transfer processing (S1206). On the other hand, when the access token is invalid, the resource server 105 notifies the image forming apparatus 101 of the completion of processing, without executing the transfer processing (S1206).

The image forming apparatus 101 displays the result of the transfer processing on the console unit 116 based on the notification from the resource server 105 to notify the user accordingly (S1207).

<Second and Subsequent Transfer Processing>

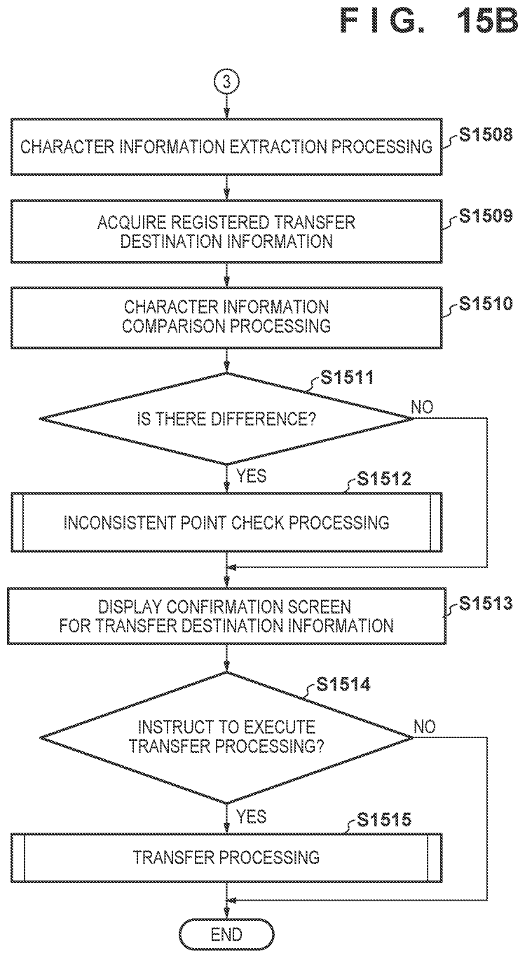

FIGS. 15A to 15C are flowcharts illustrating a procedure of the second and subsequent transfer processing performed using the shortcut button 1401 added to the home screen. The processing in each step of FIGS. 15A to 15C may be implemented in the image forming apparatus 101 when the CPU 111 reads out and executes control programs stored in the ROM 112 or the storage 114. The processing according to the procedure in FIGS. 15A to 15C is processing to be performed when a user instructs the execution of transfer processing based on registered transfer destination information. The user can instruct the execution of transfer processing based on the registered transfer destination information, for example, by pressing the shortcut button 1401 on the home screen (FIG. 3).

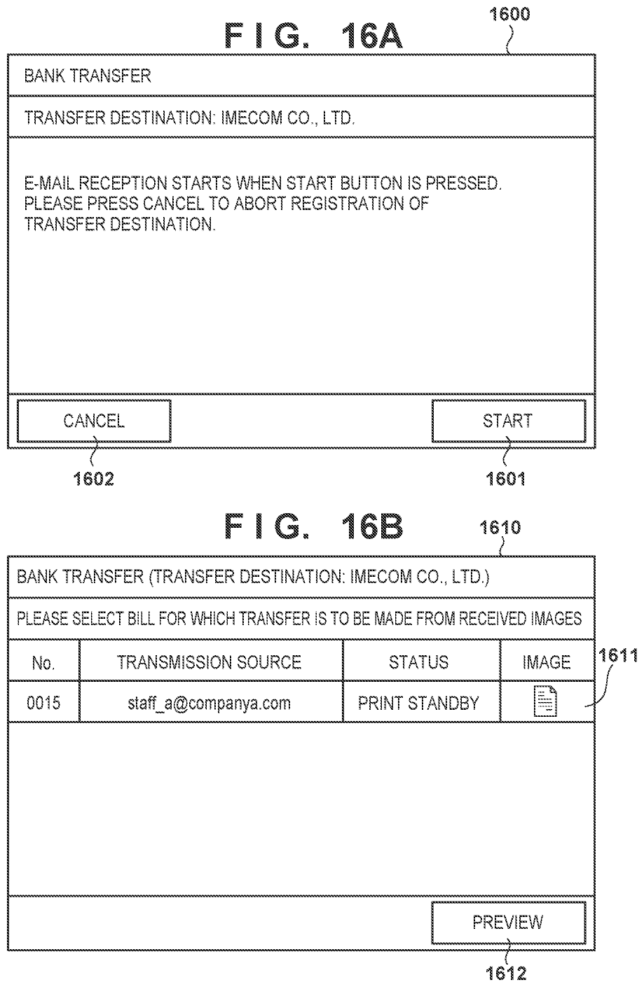

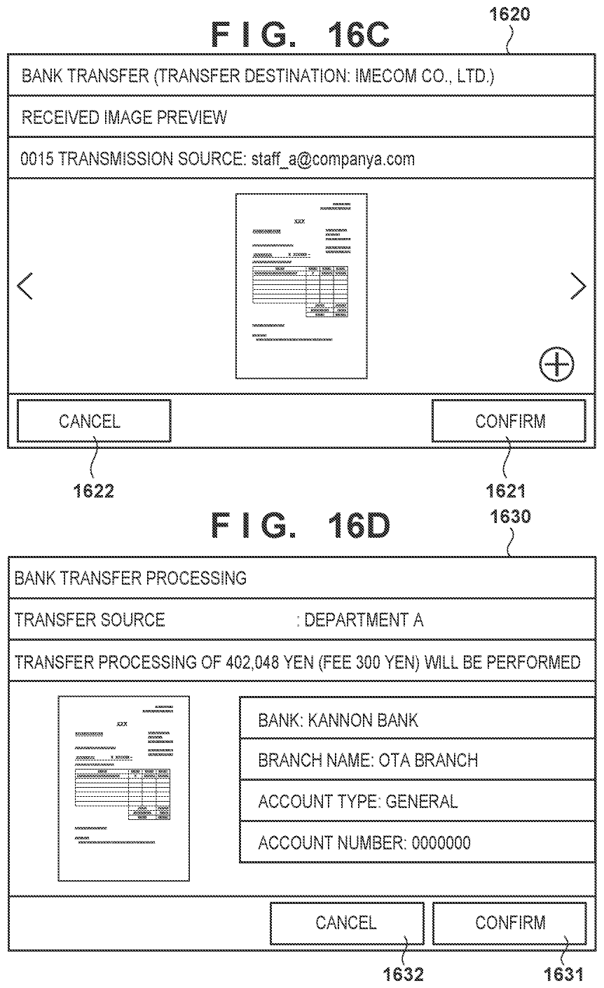

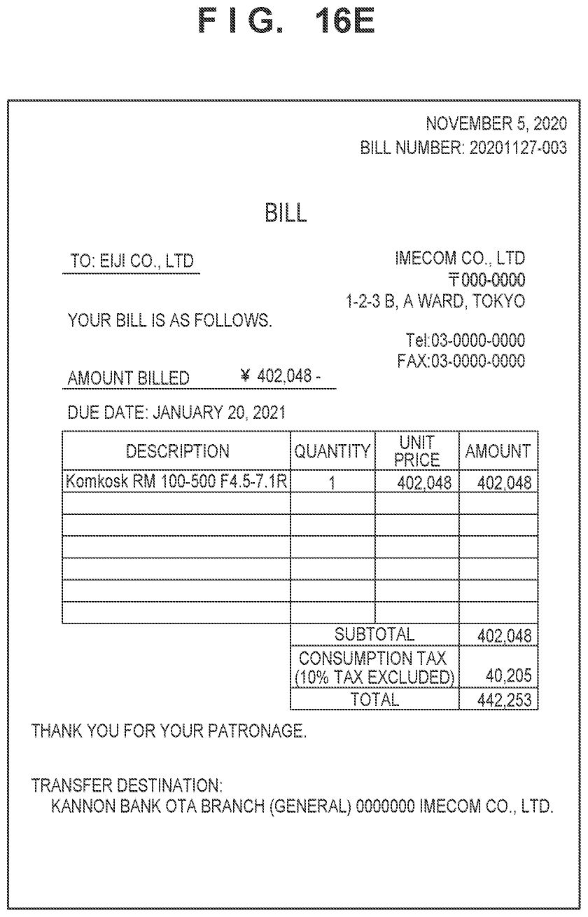

First, when the user presses the shortcut button 1401 displayed on the home screen (FIG. 14), in S1501, the CPU 111 displays a screen 1600 illustrated in FIG. 16A on the console unit 116 and receives a start instruction for e-mail reception from the user. Upon receipt of a cancellation instruction issued by pressing of a “Cancel” button 1602 on the screen 1600 (“Yes” in S1502), a sequence of processing according to the procedure in FIGS. 15A to 15C is ended. On the other hand, upon receipt of a start instruction for e-mail reception issued by pressing of a “Start” button 1601 on the screen 1600 (“No” in S1502), in S1503, the CPU 111 displays the screen 820 illustrated in FIG. 8C on the console unit 116 and starts receiving an e-mail from the mail server 107.

In S1504, the CPU 111 determines whether or not there is an e-mail received from the mail server 107, and when there is a received e-mail, advances the processing to S1505. In S1504, it is determined whether or not there is a received e-mail sent from an e-mail address matching the transmission source e-mail address that has been registered as the filter condition in association with the shortcut button 1401 in S722 described above. In a case where there is a received mail that satisfies the filter condition (that is, the transmission source e-mail address of the received e-mail matches the transmission source e-mail address registered as the filter condition), the CPU 111 advances the processing to S1505.

Note that the CPU 111 may determine whether or not there is an e-mail satisfying the filter condition in e-mails that have been previously received and stored in the storage 114, without performing the e-mail reception in S1503. In other words, it may be determined whether or not there is a received e-mail sent from an e-mail address matching the transmission source e-mail address registered as the filter condition in e-mails stored in the storage 114. This determination may be performed in response to the pressing of the “Start” button 1601 on the screen 1600 or in response to the pressing of the shortcut button 1401.

In S1505, the CPU 111 displays a screen 1610 illustrated in FIG. 16B on the console unit 116 and accepts user's selection of a received e-mail to be processed from a list 1611 of received e-mails. The list 1611 displays one or more e-mails received from the registered transmission source e-mail address (that is, one or more e-mails satisfying the filter condition). In this manner, the CPU 111 narrows down e-mails to be displayed on the console unit 116 as candidates for a processing target among e-mails received from an external apparatus by using the registered transmission source e-mail address. This makes it easier to find an image to be used for the transfer processing from a plurality of images received via e-mails.

On the other hand, when there is no received e-mail, the CPU 111 displays a screen 910 illustrated in FIG. 9B on the console unit 116 and ends a sequence of processing according to the procedure in FIGS. 15A to 15C in response to user operation of pressing the “Close” button 911.

When an e-mail is selected and a “Preview” button 1612 is pressed by the user on the screen 1610 displayed on the console unit 116 in S1505, the CPU 111 displays a preview screen 1620 illustrated in FIG. 16C on the console unit 116 in 51506. The preview screen 1620 displays a bill image corresponding to the image data attached to the received e-mail assigned with a number “No. 0015” on the screen 1610. FIG. 16E illustrates an example of a bill image based on the image data attached to the received e-mail “No. 0015”, and the bill image is displayed on the preview screen 1620.

When a “Confirm” button 1621 is pressed by the user on the preview screen 1620, the CPU 111 confirms the image to be processed (“Yes” in S1507) and advances the processing to S1508. On the other hand, when a “Cancel” button 1622 is pressed by the user on the preview screen 1620 (“No” in S1507), the CPU 111 returns the processing back to S1505 to accept again the selection of a received e-mail by the user on the screen 1610.

In S1508, the CPU 111 executes a process of extracting character information (text objects) from the bill image by the same process as in S710. Upon completion of the processing in S1508, in S1509, the CPU 111 acquires the transfer destination information and the position information stored (registered) in association with the shortcut button 1401 in the storage 114. The transfer destination information includes a character string (character information) for each item. The position information indicates positions where (character strings of) each item of the transfer destination information and the transfer amount are arranged in the bill image. Further, in S1509, the CPU 111 acquires character strings (character information) at positions indicated by the position information acquired in S1509 based on the text objects extracted through the processing in S1508. In this manner, in a case where the e-mail sent from the registered transmission source e-mail address is a processing target, the CPU 111 extracts the character information from the positions indicated by the position information registered in association with the transmission source e-mail address in the bill image attached to the e-mail that is the processing target.

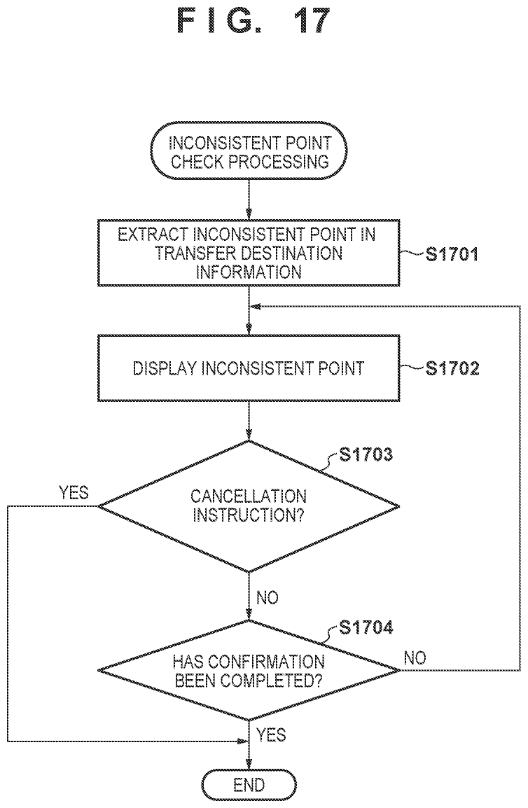

Then, in S1510, the CPU 111 performs comparison processing for comparing the character information acquired from the registered transfer destination information with the character information acquired based on the extraction processing of the text objects from the bill image. When there is no difference between the two in a result of comparison processing (the two are consistent with each other) (“No” in S1511), the CPU 111 advances the processing to S1513. On the other hand, when there is a difference between the two (the two are inconsistent with each other) (“Yes” in S1511), the CPU 111 advances the processing to S1512 to perform check processing for an inconsistent point between the registered transfer destination information and the transfer destination information acquired from the bill image. The processing in S1512 is performed according to the procedure in FIG. 17 to be described later. Upon completion of the processing in S1512, the CPU 111 advances the processing to S1513.

In S1513, the CPU 111 displays, on the console unit 116, a confirmation screen 1630 illustrated in FIG. 16D for the user to confirm the transfer destination information and the transfer amount. When the user instructs to execute the transfer processing by pressing a “Confirm” button 1631 on the confirmation screen 1630 (“Yes” in S1514), the CPU 111 advances the processing to S1515. In S1515, the CPU 111 executes the transfer processing. The transfer processing in S1515 is executed according to the sequence illustrated in FIG. 12. In this manner, the CPU 111 executes the transfer processing using the resource server 105 based on information acquired by performing character recognition processing (OCR processing) on the bill image attached to the e-mail to be processed. Upon completion of the transfer processing, the CPU 111 ends a sequence of processing according to the procedure in FIGS. 15A to 15C. On the other hand, when the user instructs to cancel the transfer processing by pressing a “Cancel” button 1632 on the confirmation screen 1630 (“No” in S1514), a sequence of processing according to the procedure in FIGS. 15A to 15C is ended.

<Check Processing for an Inconsistent Point>

FIG. 17 is a flowchart illustrating a procedure of check processing (S1512) for an inconsistent point between the registered transfer destination information and the transfer destination information acquired from the bill image.

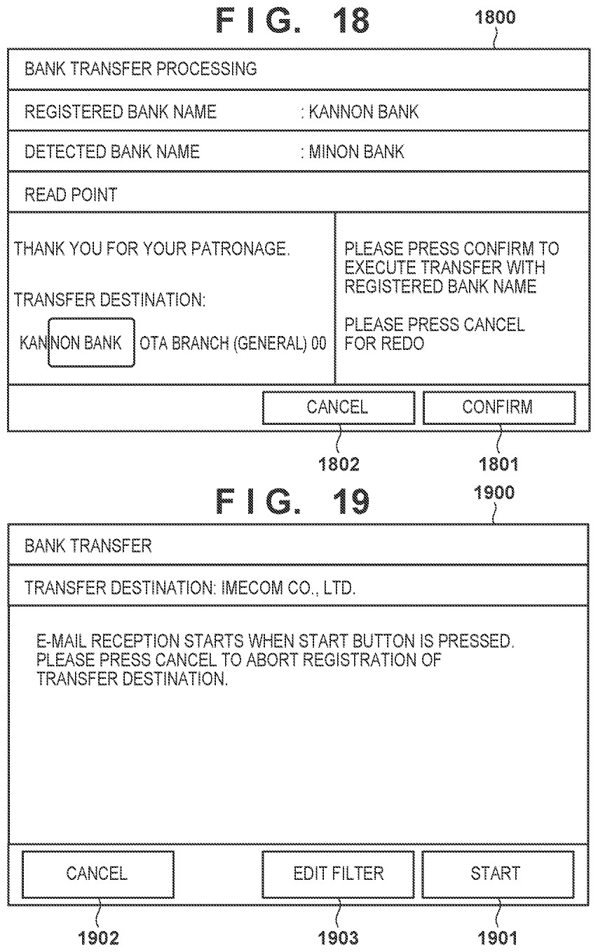

In S1701, the CPU 111 extracts a point including inconsistencies between the registered transfer destination information and the transfer destination information extracted from the bill image. Next, in S1702, the CPU 111 displays a confirmation screen 1800 illustrated in FIG. 18 on the console unit 116 to display the inconsistent point extracted. The confirmation screen 1800 is an example of a screen to be displayed when there is an inconsistency in a bank name among the items of the transfer destination information and displays the information related to the point including the inconsistency. When there is an inconsistency in another item (a branch name, an account type, or an account number) of the transfer destination information, the information related to that inconsistency is displayed in a similar manner. In this manner, in S1701, the CPU 111 displays the confirmation screen 1800 on the console unit 116 for the user to confirm information related to an item of the transfer destination information including the inconsistency. This allows the user to confirm whether or not there is a difference between a format of a bill corresponding to the registered transfer destination information and a format of a bill to be processed and to prevent a transfer failure.

When a “Cancel” button 1802 is pressed on the confirmation screen 1800 (“Yes” in S1703), the CPU 111 ends the processing according to the procedure in FIG. 17 and also ends the transfer processing according to the procedure in FIGS. 15 A to 15C. On the other hand, when the user determines that there is no problem from the result of the checking for inconsistencies in the transfer destination information, the user may cause the transfer processing based on the transfer destination information acquired from the bill image to be executed by pressing a “Confirm” button 1801 on the confirmation screen 1800. In that case, when the CPU 111 determines that the “Confirm” button 1801 has been pressed and the confirmation of the inconsistent point by the user has been completed (“YES” in S1704), the CPU 111 ends the processing according to the procedure in FIG. 17 and advances the processing to S1513. In other cases, the CPU 111 returns the processing back to S1702.

In a case where the processing is advanced to S1513, when the execution of the transfer processing is instructed by the user after the confirmation screen 1800 is displayed (S1514), the CPU 111 executes the transfer processing based on the transfer destination information and the transfer amount acquired based on the extracted character information (S1515).

As described above, in the present embodiment, the image forming apparatus 101 registers the transmission source e-mail address that indicates the transmission source of the image of the document (the bill) including the information necessary for the transfer processing using the resource server 105 that provides banking services. The image forming apparatus 101 displays, on the console unit 116, a list of one or more e-mails received from the registered transmission source e-mail address among e-mails received from an external apparatus and accepts user operation of selecting an e-mail to be processed from the list. Further, the image forming apparatus 101 executes the transfer processing using the resource server 105 based on the information acquired by performing character recognition processing (OCR processing) on the image attached to the e-mail to be processed. In this manner, the image forming apparatus 101 narrows down e-mails to be displayed on the console unit 116 as candidates for a processing target among e-mails received from an external apparatus by using the registered transmission source e-mail address. This makes it easier for the image forming apparatus 101 to find an image to be used for the transfer processing from a plurality of images received via e-mails.

According to one aspect of the present embodiment, after the completion of the transfer processing, the image forming apparatus 101 may register the transfer destination information used for the transfer processing and the position information indicating the positions where the character information of each item of the transfer destination information and the transfer amount are arranged in the attached image in association with the transmission source e-mail address of the e-mail, for use in the next and subsequent transfer processing. This makes it possible to reuse the registered transfer destination information for the next and subsequent transfer processing and prevent a transfer error due to errors in transfer destination information.

According to one aspect of the present embodiment, at the time of the registration described above, the image forming apparatus 101 may add an instruction object (the shortcut button 1401) to be used by the user to instruct the execution of the transfer processing based on the transfer destination information registered in association with the transmission source e-mail address to the home screen displayed on the console unit 116. This allows the user to easily instruct the reuse of the transfer destination information registered in association with the transmission source e-mail address by using the shortcut button 1401 and thus can increase the convenience for the user.

### Second Embodiment

Regarding the second and subsequent transfer processing using the shortcut button 1401 added to the home screen, the first embodiment has described an example in which a transmission source e-mail address of a received e-mail used for the first transfer processing is used as a filter condition for e-mail reception. The second embodiment will describe an example in which a transmission source e-mail address is registered as one of filter conditions and the filter conditions are edited in accordance with user operation. In the present embodiment, it is possible to add an additional transmission source e-mail address and a subject as the filter conditions and further edit or delete the filter conditions. In the following, the second embodiment will be described with a focus on differences from the first embodiment, and description of portions common to the first embodiment will be omitted.

In the present embodiment, when executing the second and subsequent transfer processing using the shortcut button 1401 (FIG. 14) added to the home screen, the image forming apparatus 101 (the CPU 111) display a screen 1900 illustrated in FIG. 19 on the console unit 116. When a “Start” button 1901 or a “Cancel” button 1902 is pressed by a user on the screen 1900, the CPU 111 executes processing similar to that performed when the corresponding button 1601 or 1602 included in the screen 1600 (FIG. 16A) is pressed. That is, upon receipt of a start instruction for e-mail reception issued by pressing of the button 1901, the CPU 111 starts receiving e-mails from the mail server 107 (S1503).

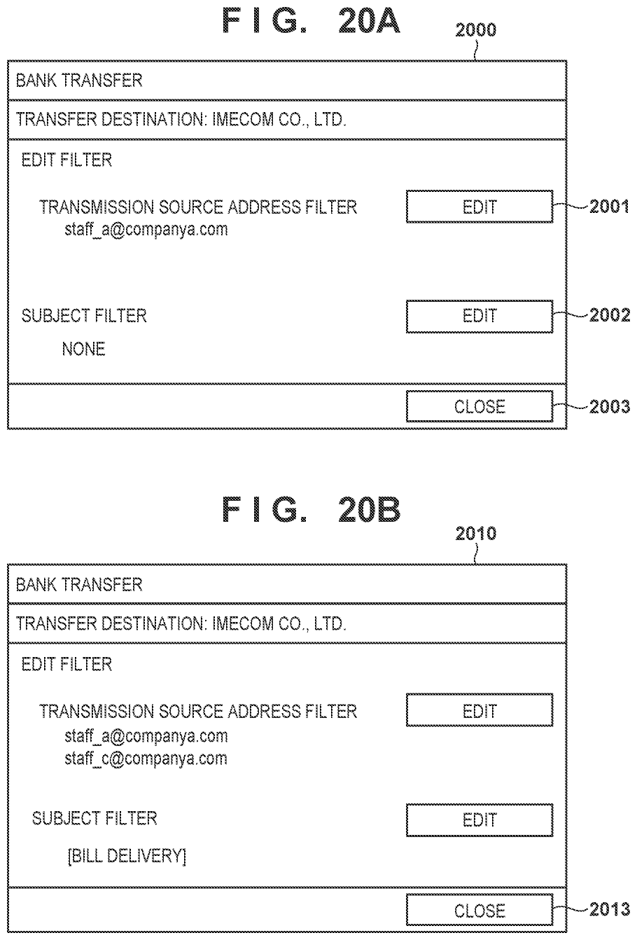

In the present embodiment, when a “Edit filter” button 1903 is pressed by the user on the screen 1900, the CPU 111 displays a screen 2000 illustrated in FIG. 20A on the console unit 116. The user can edit the filter conditions to be used at the time of the mail reception by using the screen 2000. FIG. 20A illustrates an example of a state in which one transmission source e-mail address is set as a transmission source e-mail address filter and no subject keyword is set as a subject filter. When a button 2001 or 2002 is pressed, the CPU 111 displays a software keyboard (not illustrated) on the screen 1900 and accepts user operation of adding, editing or deleting a transmission source e-mail address and a subject keyword. FIG. 20B illustrates an example in which the filter conditions to be applied at the time of the mail reception are edited by the user on the screen 2000. On a screen 2010 illustrated in FIG. 20B, one transmission source e-mail address is added to the transmission source e-mail address filter and a subject keyword of “[delivery of bill]” is added to the subject filter as filter conditions.

When a “Close” button 2003 (2013) is pressed on the screen 2000 (2010), the CPU 111 displays the screen 1900 on the console unit 116 again and accepts user's instruction (a start instruction for mail reception). In this manner, when the “Start” button 1901 is pressed by the user with the filter conditions changed, the CPU 111 determines whether or not there is a received e-mail satisfying the changed filter conditions upon receipt of e-mails from the mail server 107. In a case where there is a received e-mail satisfying the filter conditions, the CPU 111 displays the screen 1610 on the console unit 116 and accepts user's selection of a received e-mail to be processed from the list 1611 including such a received e-mail (S1505). Further, the CPU 111 executes the transfer processing according to the user's instruction (S1515).

As described above, in the present embodiment, the image forming apparatus 101 registers a transmission source e-mail address as one of the filter conditions for identifying e-mails to be displayed as candidates for a processing target among e-mails received from an external apparatus. Further, the image forming apparatus 101 edits the filter conditions in accordance with user operation. The image forming apparatus 101 may be configured such that a transmission source e-mail address of an e-mail can be added as a filter condition or may be configured such that a keyword included in a subject of an e-mail can be added as a filter condition. This allows the user to arbitrarily edit the filter conditions for identifying an e-mail to be processed among received e-mails and thus can increase the convenience for the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-066067, filed Apr. 8, 2021, which is hereby incorporated by reference herein in its entirety.

What is claimed is:

1. An image processing apparatus comprising:
a registration unit configured to register a transmission source e-mail address indicating a transmission source of an image of a document including information necessary for transfer processing using a server apparatus providing banking services;
an acceptance unit configured to display, on a display unit, a list of one or more e-mails received from the transmission source e-mail address registered by the registration unit among e-mails received from an external apparatus, and accept user operation of selecting an e-mail to be processed from the list; and
an execution unit configured to execute the transfer processing using the server apparatus based on information acquired by performing character recognition processing on an image attached to the e-mail to be processed.

2. The image processing apparatus according to claim 1, wherein
the registration unit registers transfer destination information and a transmission source e-mail address in association with each other, and
when a user instructs an execution of transfer processing based on the transfer destination information registered, the acceptance unit displays a list of one or more e-mails received from the transmission source e-mail address registered in association with the transfer destination information and accepts the user operation.

3. The image processing apparatus according to claim 2, wherein
when a user instructs an execution of transfer processing without using the transfer destination information registered,
the acceptance unit displays a list of e-mails received from an external apparatus and accepts user operation of selecting an e-mail to be processed from the list, and
after completion of the transfer processing based on the image attached to the e-mail to be processed, the registration unit registers transfer destination information used for the transfer processing and a transmission source e-mail address of the e-mail in association with each other.

4. The image processing apparatus according to claim 3, wherein
the registration unit registers the transfer destination information used for the transfer processing together with position information indicating positions where character information of each item of the transfer destination information and a transfer amount is arranged in the image, in association with the transmission source e-mail address, and
the execution unit acquires character information of the transfer destination information and the transfer amount by the character recognition processing on positions, in the image attached to the e-mail to be processed, indicated by the position information registered in association with the transmission source e-mail address and executes the transfer processing.

5. The image processing apparatus according to claim 4, wherein
in a case where the transfer destination information acquired by the character recognition processing is inconsistent with the transfer destination information registered in association with the transmission source e-mail address, the execution unit displays, on the display unit, a confirmation screen configured to enable the user to confirm information of a transfer destination information item in which an inconsistency is caused, and
in a case where an execution of the transfer processing is instructed by a user after the confirmation screen is displayed, the execution unit executes the transfer processing based on the transfer destination information and the transfer amount acquired by the character recognition processing.

6. The image processing apparatus according to claim 2, wherein
the registration unit further adds an instruction object for a user to instruct an execution of the transfer processing based on the transfer destination information registered in association with the transmission source e-mail address to an operation screen displayed on the display unit, the operation screen being for selection of a function of the image processing apparatus, and
when an instruction is issued by a user using the instruction object displayed on the operation screen, the acceptance unit displays a list of one or more e-mails received from the transmission source e-mail address registered and accepts the user operation.

7. The image processing apparatus according to claim 2, wherein the transfer destination information includes information indicating at least any one of a registration name for identifying a transfer destination, a bank name, a branch name, an account type, and an account number.

8. The image processing apparatus according to claim 1, wherein
the acceptance unit displays, on the display unit, a preview screen indicating an image attached to an e-mail selected from the list, and
when a determination of a processing target is instructed by a user on the preview screen, the execution unit executes the transfer processing based on information acquired by performing the character recognition processing on the image displayed on the preview screen.

9. The image processing apparatus according to claim 1, wherein
the registration unit registers the transmission source e-mail address as one of filter conditions for identifying e-mails to be displayed on the display unit as candidates for a processing target among e-mails received from an external apparatus, and
the image processing apparatus further comprises an editing unit configured to edit the filter conditions according to user operation.

10. The image processing apparatus according to claim 9, wherein the editing unit can add a transmission source e-mail address of an e-mail as the filter conditions.

11. The image processing apparatus according to claim 9, wherein the editing unit can add a keyword included in a subject of an e-mail to the filter conditions.

12. A method of controlling of an image processing apparatus, the method comprising:
registering a transmission source e-mail address indicating a transmission source of an image of a document including information necessary for transfer processing using a server apparatus providing banking services;
displaying, on a display unit, a list of one or more e-mails received from the registered transmission source e-mail address among e-mails received from an external apparatus, and accepting user operation of selecting an e-mail to be processed from the list; and
executing the transfer processing using the server apparatus based on information acquired by performing character recognition processing on an image attached to the e-mail to be processed.

13. A non-transitory computer-readable storage medium storing a computer program for causing a computer to execute method of controlling of an image processing apparatus, the method comprising:
registering a transmission source e-mail address indicating a transmission source of an image of a document including information necessary for transfer processing using a server apparatus providing banking services;
displaying, on a display unit, a list of one or more e-mails received from the registered transmission source e-mail address among e-mails received from an external apparatus, and accepting user operation of selecting an e-mail to be processed from the list; and
executing the transfer processing using the server apparatus based on information acquired by performing character recognition processing on an image attached to the e-mail to be processed.
